(19) United States
(12) Patent Application Publication
(10) Pub. No.: US 2024/0421967 A1
(43) Pub. Date: Dec. 19, 2024

(54) ADAPTIVE RADAR RESOURCE POOL FOR INTERFERENCE-FREE MULTI-RADAR CO-EXISTENCE

(71) Applicant: QUALCOMM Incorporated, San Diego, CA (US)

(72) Inventors: Stelios STEFANATOS, San Diego, CA (US); Kapil GULATI, Belle Mead, NJ (US); Junyi LI, Greentown, PA (US); Preeti KUMARI, San Diego, CA (US)

(21) Appl. No.: 18/705,906

(22) PCT Filed: Dec. 13, 2022
(86) PCT No.: PCT/US2022/081452

§ 371 Date: Apr. 29, 2024

(30) Foreign Application Priority Data
Jan. 25, 2022 (GR) 20220100067

(51) Int. Cl. H04L 5/00; G01S 7/02; G01S 13/931

(52) U.S. Cl. CPC H04L 5/0094; G01S 7/0232; G01S 7/0235; G01S 13/931; H04L 5/0062; G01S 2013/9316

(57) ABSTRACT

Certain aspects of the present disclosure provide techniques for wireless communication by a radar device. The radar device determines a resource pool configuration indicating a radar band partitioned into a plurality of non-overlapping subbands. At least two of the plurality of non-overlapping subbands use resource elements (REs) that differ in at least one of a frequency size or a time duration. The radar device transmits a radar waveform using at least one RE within a subband of the plurality of non-overlapping subbands.

### CROSS-REFERENCE TO RELATED APPLICATION(S)

This application claims priority to Greece application No. 20220100067 filed Jan. 25, 2022, which is assigned to the assignee hereof and incorporated by reference herein in its entirety.

### INTRODUCTION

Aspects of the present disclosure relate to wireless communications, and more particularly, to techniques for defining a radar resource pool for interference-free multi-radar co-existence.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a radar device, comprising: determining a resource pool configuration indicating a radar band partitioned into a plurality of non-overlapping subbands, wherein at least two of the plurality of non-overlapping subbands use resource elements (REs) that differ in at least one of a frequency size or a time duration; and transmitting a radar waveform using at least one RE within a subband of the plurality of non-overlapping subbands.

Another aspect provides a method for wireless communication by a network entity, comprising: defining a resource pool configuration indicating a radar band partitioned into a plurality of non-overlapping subbands, wherein at least two of the plurality of non-overlapping subbands use REs that differ in at least one of a frequency size or a time duration; and configuring, a radar device, with the resource pool configuration.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station (BS) and user equipment (UE).

FIGS. 3A-3D depict various example aspects of data structures for a wireless communication network.

FIGS. 4A-4B show diagrammatic representations of example vehicle-to-everything (V2X) systems.

FIG. 5A illustrates a vehicle using a radar device to detect target objects in an environment.

FIG. 5B illustrates example time and frequency plot showing transmission of signals and reception of reflected signals via a radar device of a vehicle.

FIG. 6 illustrates example environment in which interfering signals are produced by multiple radar devices of vehicles operating in the environment.

FIG. 7 illustrates example underutilized resource elements (REs).

FIG. 8 is a flow diagram illustrating example operations for wireless communication by a radar device.

FIG. 9 is a flow diagram illustrating example operations for wireless communication by a network entity.

FIG. 10 depicts example radar band partitioned into three subbands.

FIG. 11 depicts example frequency-modulated continuous wave (FMCW) dedicated subbands.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for defining a radar resource pool for interference-free multi-radar co-existence.

Multiple radar devices operating in a same environment (and transmitting in overlapping time and frequency resources) may produce interfering signals. These interfering signals may lead to multi-radar interference and impact detectability of target objects within the environment. One approach to eliminate the multi-radar interference is by multiplexing radar waveforms of the different radar devices via a coordinated channel access. However, in some scenarios (e.g., congested scenarios where several radar devices operate in a particular area), a contention-based approach (e.g., a listen before talk (LBT)-based approach) may be inefficient for the radar devices (e.g., due to long wait times, collisions, etc.). In such scenarios, a scheduled channel access approach may become preferable, which requires defining resources to select, reserve and, eventually, transmit radar waveforms in.

The techniques described herein define a radar resource pool, to efficiently support a large number of radar devices and different (e.g., incompatible) radar waveforms of the radar devices. The radar resource pool may be dynamically adapted based on current operational conditions. The techniques described herein may improve radar waveform multiplexing efficiency for the radar devices (e.g., frequency-modulated continuous wave (FMCW) radar devices used in automotive industry), and thereby reducing or eliminating multi-radar interference.

### Introduction to Wireless Communication Networks

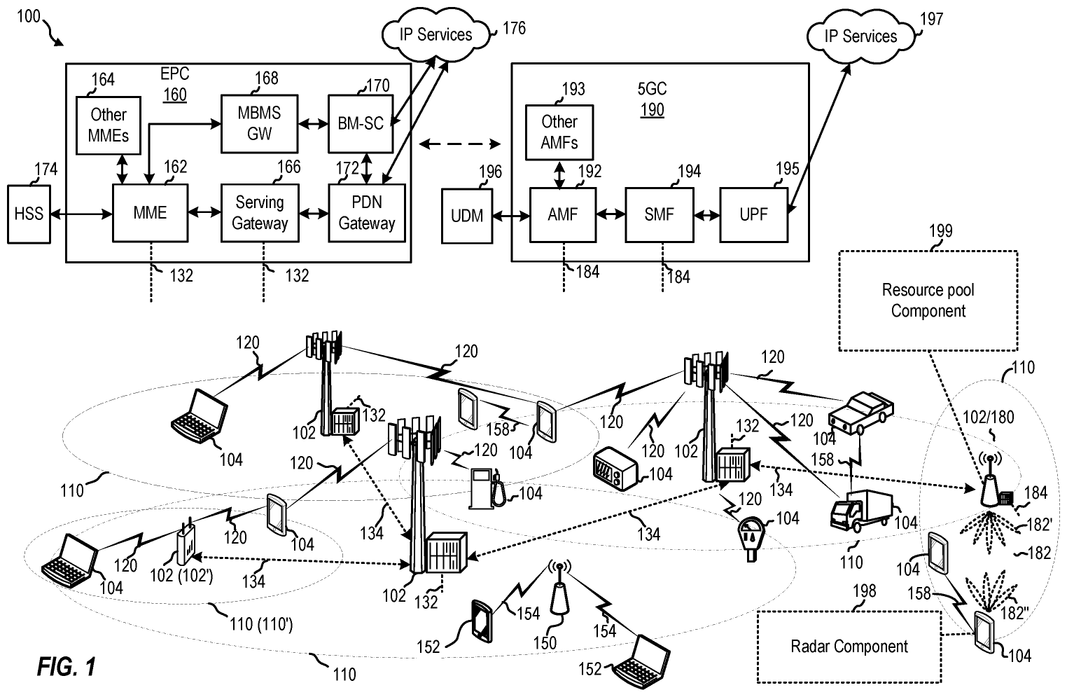

FIG. 1 depicts an example of a wireless communication network 100, in which aspects described herein may be implemented.

Generally, wireless communication network 100 includes base stations (BSs) 102, user equipments (UEs) 104 (e.g., having one or more radar devices), one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs may include and/or be referred to as a gNB, NodeB, eNB, ng-eNB (e.g., an eNB that has been enhanced to provide connection to both EPC 160 and 5GC 190), an access point, a base transceiver station, a radio BS, a radio transceiver, or a transceiver function, or a transmission reception point in various contexts.

A BS, such as BS 102, may include components that are located at a single physical location or components located at various physical locations. In examples in which the BS includes components that are located at various physical locations, the various components may each perform various functions such that, collectively, the various components achieve functionality that is similar to a BS that is located at a single physical location. As such, a BS may equivalently refer to a standalone BS or a BS including components that are located at various physical locations or virtualized locations. In some implementations, a BS including components that are located at various physical locations may be referred to as or may be associated with a disaggregated radio access network (RAN) architecture, such as an Open RAN (O-RAN) or Virtualized RAN (VRAN) architecture. In some implementations, such components of a BS may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power BS) may have a coverage area 110′ that overlaps the coverage area 110 of one or more macrocells (e.g., high-power BSs).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming.

In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

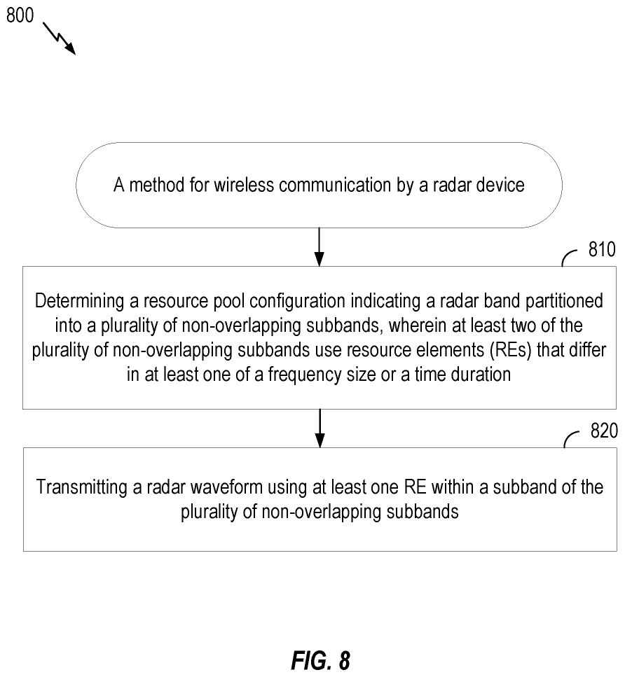

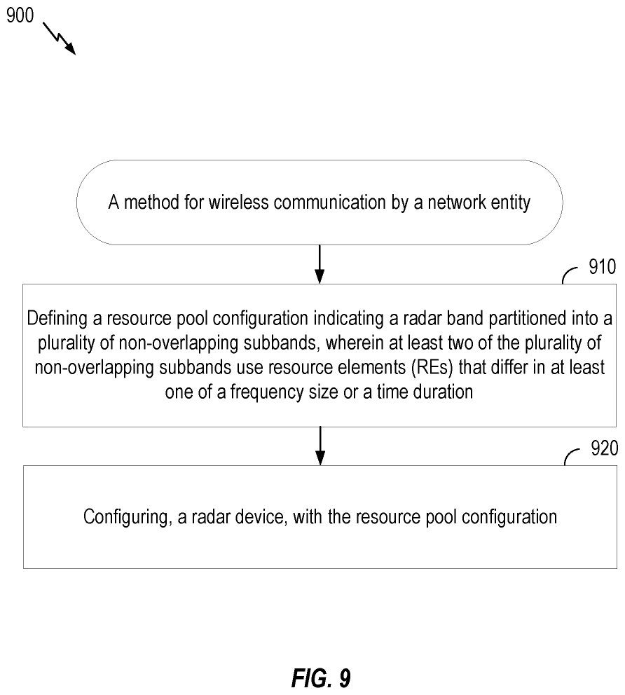

Wireless communication network 100 includes resource pool component 199, which may be configured to perform operations 900 of FIG. 9. Wireless communication network 100 further includes radar component 198, which may be configured to perform operations 800 of FIG. 8.

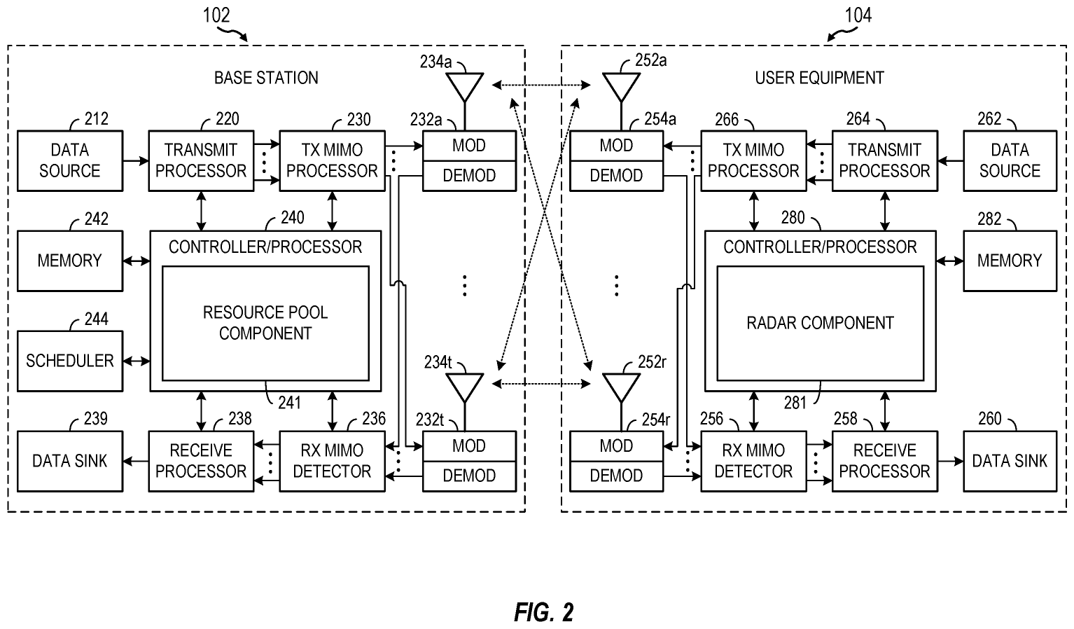

FIG. 2 depicts aspects of an example BS 102 and a UE 104 (e.g., having a radar device). Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes resource pool component 241, which may be representative of resource pool component 199 of FIG. 1. Notably, while depicted as an aspect of controller/processor 240, resource pool component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes radar component 281, which may be representative of radar component 198 of FIG. 1. Notably, while depicted as an aspect of controller/processor 280, radar component 281 may be implemented additionally or alternatively in various other aspects of UE 104 in other implementations.

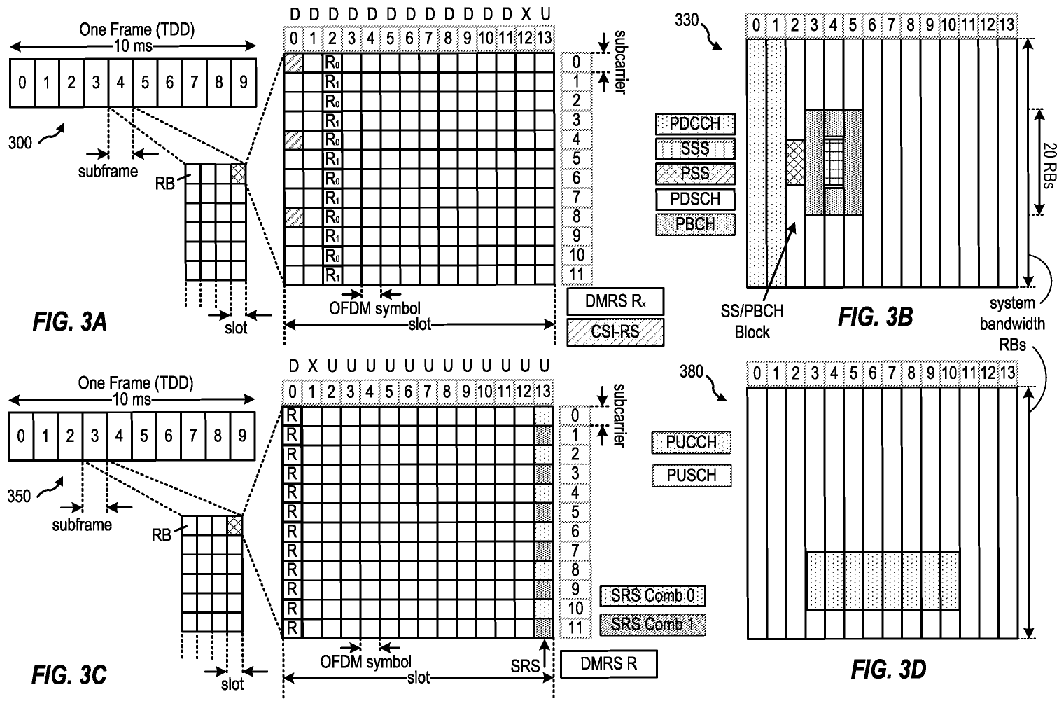

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHZ-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., BS 180) configured to communicate using mmWave/near mmWave radio frequency bands may utilize beamforming (e.g., 182) with a user equipment (UE) (e.g., UE 104) to improve path loss and range.

### Example Sidelink Communication

User equipments (UEs) (e.g., vehicles including radar devices) communicate with each other using sidelink signals. Real-world applications of sidelink communications may include UE-to-network relaying, vehicle-to-vehicle (V2V) communications, vehicle-to-everything (V2X) communications, Internet of Everything (IoE) communications, IoT communications, mission-critical mesh, and/or various other suitable applications.

A sidelink signal refers to a signal communicated from one UE to another UE without relaying that communication through a scheduling entity (e.g., UE or a network entity), even though the scheduling entity may be utilized for scheduling and/or control purposes. In some examples, the sidelink signal is communicated using a licensed spectrum (unlike wireless local area networks, which typically use an unlicensed spectrum). One example of sidelink communication is PC5, for example, as used in V2V, long term evolution (LTE), and/or new radio (NR).

Various sidelink channels are used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal UEs to discover each other. The PSCCH may carry control signaling such as sidelink resource configurations, resource reservations, and other parameters used for data transmissions. The PSSCH may carry the data transmissions. The PSFCH may carry feedback such as acknowledgement (ACK) and/or negative ACK (NACK) information corresponding to transmissions on the PSSCH.

In some NR systems, a two stage sidelink control information (SCI) is supported. The two stage SCI may include a first stage SCI (e.g., SCI-1) and a second stage SCI (e.g., SCI-2). SCI-1 may include resource reservation and allocation information. SCI-2 may include information that can be used to decode data and to determine whether a UE is an intended recipient of a transmission. SCI-1 and/or SCI-2 may be transmitted over a PSCCH.

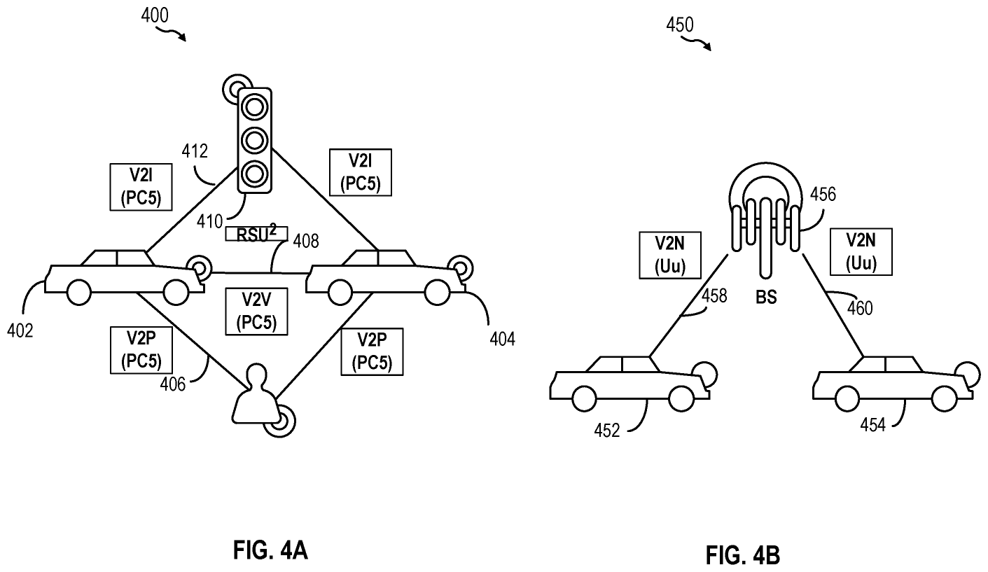

FIG. 4A and FIG. 4B show diagrammatic representations of example V2X systems. For example, vehicles shown in FIG. 4A and FIG. 4B may communicate via sidelink channels and relay sidelink transmissions. V2X is a vehicular technology system that enables vehicles to communicate with traffic and an environment around them using short-range wireless signals, known as sidelink signals.

The V2X systems shown in FIG. 4A and FIG. 4B provide two complementary transmission modes. A first transmission mode, shown by way of example in FIG. 4A, involves direct communications (for example, also referred to as sidelink communications) between participants in proximity to one another in a local area. A second transmission mode, shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including V2V communications) is illustrated with two vehicles 402, 404. A first transmission mode allows for direct communication between different participants in a given geographic location. As illustrated, a vehicle 402 can have a wireless communication link 406 with an individual through a PC5 interface. Communications between the vehicles 402 and 404 may also occur through a PC5 interface 408. In a like manner, communication may occur from the vehicle 402 to other highway components (for example, roadside unit (RSU) 410), such as a traffic signal or sign through a PC5 interface 412. With respect to each communication link illustrated in FIG. 4A, two-way communication may take place between devices, therefore each device may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system 400 may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. Network communications may occur through discrete nodes, such as a network entity 456 that sends and receives information to and from (for example, relays information between) the vehicles 452, 454. The network communications through vehicle to network (V2N) links 458 and 460 may be used, for example, for long-range communications between the vehicles 452, 454, such as for communicating the presence of a car accident a distance ahead along a road or highway. Other types of communications may be sent by a wireless node to the vehicles 452, 454, such as traffic flow conditions, road hazard warnings, environmental/weather reports, and service station availability, among other examples. Such data can be obtained from cloud-based sharing services.

### Example Radar Device Operation and Interference in Multi-Radar Coexistence

User equipments (UEs) (e.g., the vehicles 402, 404, 452, and 454 in FIG. 4A and FIG. 4B) are equipped with sensors (e.g., radar devices) that allow these vehicles to better perceive an environment (e.g., driving on a road) in which the vehicles operate. For example, a radar device may allow a particular vehicle to sense target objects (e.g., road obstacles, other vehicles, etc.) in the environment, and thereby enhancing situational awareness when operating in the environment. Sensing these target objects within the environment may help the vehicle to improve driving decisions and maneuvers.

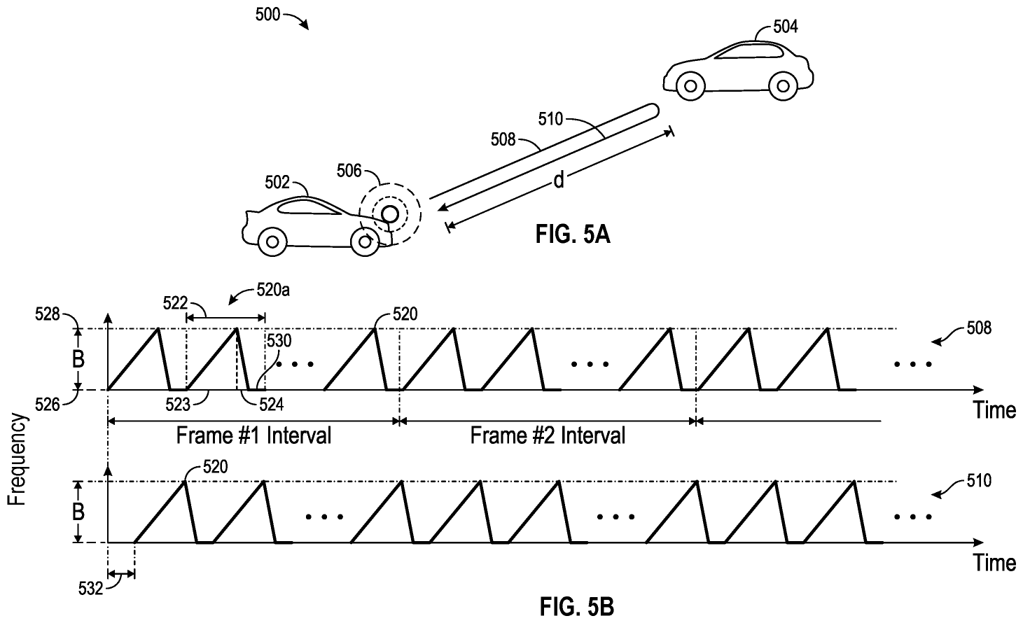

FIG. 5A illustrates using a radar device to detect target objects in an environment 500. As illustrated, the environment 500 includes a first vehicle 502 and a second vehicle 504. In some cases, the first vehicle 502 may be an example of any one of the vehicles 402, 404, 452, or 454 illustrated in FIG. 4A and FIG. 4B. Additionally, in some cases, the first vehicle 502 may incorporate or be an example of the UE 120a illustrated in FIGS. 1 and 2.

The first vehicle 502 includes a radar device that is configured to emit/transmit signals 506 to detect target objects in the environment 500. The signals 506 may include frequency-modulated continuous wave (FMCW) signals, known as chirp transmissions, and may be generated based on a set of parameters. In some cases, the signals 506 may be transmitted in a gigahertz (GHz) frequency range (e.g., 24 GHz, 35 GHz, 76.5 GHZ, 79 GHz, etc.) in one or more transmission frames. As shown in FIG. 5A, the signals 506 may include one or more signals 508, which are emitted by the radar device of the first vehicle 502. Thereafter, when a target object, such as the second vehicle 504, is present in the environment 500, the one or more signals 508 may be reflected off of the second vehicle 504 and may be received by the radar device of the first vehicle 502 after a certain propagation delay (τ).

This propagation delay may be represented as follows:

$$τ = \frac{2 d}{c} ,$$

where d is a distance between the first vehicle 502 and the second vehicle 504 and c is the speed of light. Because the speed of light (c) is constant, the first vehicle 502 is able to determine the distance (d) of the second vehicle 504 relative to a position of the first vehicle 502 based on the propagation delay (τ) between when the one or more signals 508 are emitted by the radar device of the first vehicle 502 and when one or more reflected signals 510 (e.g., reflections of the one or more signals 508) are received by the radar device of the first vehicle 502. In other words, the first vehicle 502 may determine the distance (d) of the second vehicle 504 by emitting the one or more signals 508 and measuring the time it takes for the one or more reflected signals 510 to be received by the radar device of the first vehicle 502.

FIG. 5B shows a time and frequency plot illustrating transmission of signals and reception of reflected signals, such as the one or more signals 508 and the one or more reflected signals 510, by the radar device of the first vehicle 502. As shown, the radar device of the first vehicle 502 is configured to transmit (e.g., emit) the one or more signals 508. The one or more signals 508 are transmitted in a plurality of frames defined as a particular interval in time, such as frame interval #1, frame interval #2, etc.

The one or more signals 508 within each frame interval may include a plurality of chirp transmissions 520 associated with a particular carrier frequency. A number of chirp transmissions within each frame interval may be the same. Each chirp transmission may have a total duration 522 consisting of a frequency ramp up duration 523 and a frequency ramp down duration 524. The frequency ramp up duration 523 includes a period of time in which a transmission frequency of a chirp 520a of the plurality of chirp transmissions 520 is increased from an initial transmission frequency 526 to a maximum transmission frequency 528. A difference between the initial transmission frequency 526 and the maximum transmission frequency 528 represents a bandwidth (B) or frequency sweep of the chirp transmission 520a. Similarly, the frequency ramp down duration 524 includes a period of time in which the transmission frequency of the chirp transmission 520a is decreased from the maximum transmission frequency 528 to the initial transmission frequency 526. Following the chirp transmission 520a there may be a duration 530 representing an inactive period occurring prior to the transmission of a subsequent chirp of the plurality of chirp transmissions 520.

As noted above, after the one or more signals 508 are transmitted by the first vehicle 502, the one or more signals 508 may be reflected off of the second vehicle 504 and received by the radar device of the first vehicle 502 as the one or more reflected signals 510. As shown in FIG. 5B, the one or more reflected signals 510 include the one or more chirp transmissions 520 of the one or more signals 508, which may be received by the radar device of the first vehicle after a propagation delay (τ) 532 after being transmitted in the one or more signals 508.

Based on the propagation delay 532 associated with the one or more reflected signals 510, the radar device of the first vehicle 502 may determine the distance of the second vehicle 504 according to cτ/2, where τ is the propagation delay and c is the speed of light. The radar device of the first vehicle 502 may also be able to determine a relative radial velocity and a direction (e.g., if equipped with multiple receive (RX) antennas) in a similar manner.

This procedure of transmitting/emitting the one or more signals 508 and receiving the one or more reflected signals 510 may be repeated by the radar device of the first vehicle 502 over multiple successive frames. Each frame will result in a number of “detections”, one for each target object in the environment 500, and indicate the target object distance/velocity/direction at the time the frame was transmitted. The radar device of the first vehicle 502 may then combine the detections in the successive frames, resulting in a time series of detections of the target objects that are input to a data-association and track-detection filter. In case of a single target object, the task of the data-association and track-detection filter is to smooth out the detections of the target object (e.g., from noise impairments) and create a “clean” trajectory (or track) of the target object in the environment 500. In case of multiple target objects, the task of the data-association and track-detection filter is to assign the detections of each frame to distinct target objects and using previous target object detections create the trajectories of all the target objects present in the environment 500. The data-association and track-detection filter is also responsible for detecting and tracking new target objects within the environment 500 as well as “dropping” target objects that cannot be associated to any track or that are not associated with any new detections (e.g., the target objects that have left the environment 500).

However, while radar devices generally improve situational awareness in an environment, such as the environment 500, the operation of many radar devices in the environment, associated with different vehicles, may negatively impact the accuracy to sense target objects within the environment. For example, multiple radar devices operating in the same environment (and transmitting in overlapping time and frequency resources) may produce interfering signals. These interfering signals may create ghost targets (e.g., targets that do not actually exist in a detected location, also known as “false alarms”) and/or result in an increase of a noise floor, which impacts detectability of (actual) target objects within the environment.

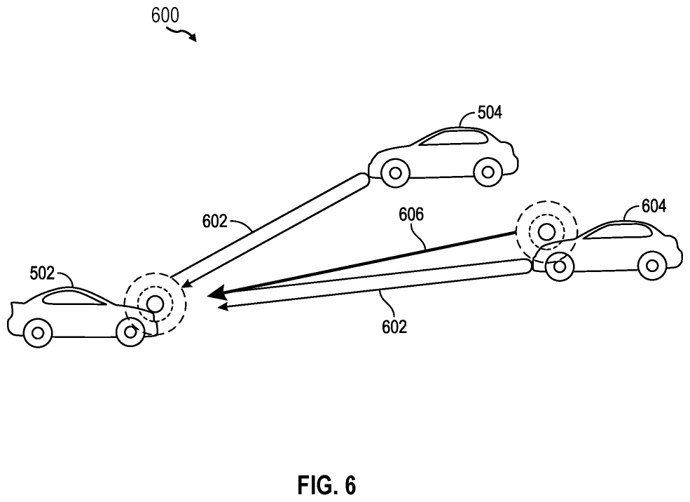

FIG. 6 illustrates an environment 600 in which interfering signals are produced by multiple radar devices operating in the environment 600. For example, as illustrated in FIG. 6, the environment 600 again includes the first vehicle 502 and the second vehicle 504. The first vehicle 502 may transmit one or more signals 602 via a radar device in the environment 600 for detecting and tracking target objects within the environment 600.

The environment 600 includes a third vehicle 604, which may include a radar device configured to transmit signals for detecting and tracing target objects within the environment 600. In some cases, when radars devices, such as the radar device of the first vehicle 502 and the radar device of the third vehicle 604, operate over a same frequency, signals from these radar devices may interfere with each other. For example, as shown, in addition to the radar device of the first vehicle 502 transmitting the one or more signals 602 and receiving corresponding reflections, the radar device of the first vehicle 502 may also receive a direct signal 606 from the radar device of the third vehicle 604.

### Aspects Related to Adaptive Radar Resource Pool for Interference-free Multi-Radar Co-existence

In some cases, to eliminate multi-radar interference, a scheduled channel access technique is implemented to multiplex radar transmissions of radar devices via a coordinated channel access (e.g., an orthogonal channel access). For example, each radar device may transmit a radar waveform in time-frequency resources that no other radar device (e.g., in range) transmits in. In such cases, there may be a need for a common time-frequency resource pool, so that each radar device is aware of resources each radar device can reserve and/or transmit in.

Techniques described herein define a radar resource pool for interference-free multi-radar co-existence. The radar resource pool may efficiently support a large number of active radar devices, is flexible to support arbitrary (e.g., incompatible) radar waveforms (e.g., no restrictions on a waveform type such a frequency-modulated continuous wave (FMCW) or a phase-modulated continuous wave (PMCW)), and can be dynamically adapted based on current operational conditions (or radar devices service requests). The techniques described herein may improve radar waveform multiplexing efficiency for the radar devices (e.g., FMCW radar devices used in automotive industry), and thereby reducing or eliminating multi-radar interference.

In certain aspects, a radar band (e.g., indicated by a radar resource pool configuration) is partitioned into subchannels (e.g., of fixed bandwidth) in frequency and slots (e.g., of fixed duration) in time. A resource corresponding to one subchannel and one slot is a resource element (RE), and constitutes a minimum amount of resources a radar transmission can reserve and transmit in. In some cases, a size of each RE is pre-configured and fixed. In some cases, the size of each RE is changed infrequently (e.g., in order of hours or days).

In certain aspects, a radar waveform burst (e.g., a frame) from a radar device exclusively reserves/utilizes a number of REs. If a radar waveform does not fit a single RE, multiple REs are utilized (e.g., to accommodate time/bandwidth requirements of a single frame transmission). These REs are adjacent in time and/or frequency. However, in some cases, the radar waveform may not fully utilize one or more reserved REs (e.g., in time and/or frequency) due to a mismatch between a bandwidth/duration of the radar waveform and a bandwidth/duration of the REs.

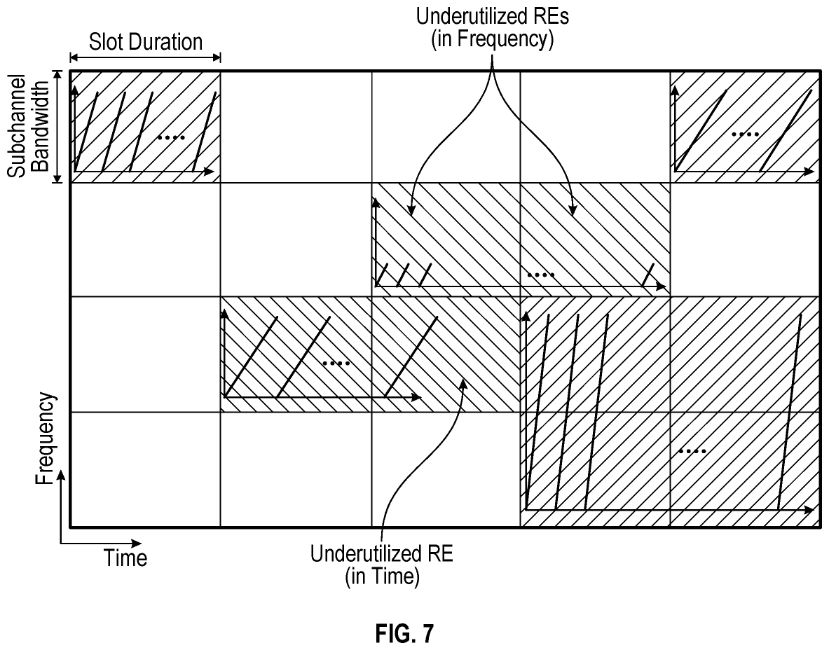

FIG. 7 depicts an example of a resource pool and multiple radar devices transmitting on different sets of REs (and thereby achieving interference-free operation). As illustrated, different radar waveforms from the different radar devices do not occupy full frequency and/or time resources of one or more utilized REs, and thereby resulting in underutilized REs. This is because all REs are of equal size and cannot efficiently support all the radar waveforms. For example, a single slot will be used whether the radar transmission burst is active for 100% of the slot duration or just 1% of the slot duration (and similarly for the bandwidth).

One technique to avoid wasting time-frequency resources due to mismatch of the REs with the radar waveforms is to consider a very fine granularity of the resources. In such cases, a radar waveform burst may be covered by many small-size REs (e.g., with potentially very small efficiency loss). However, this technique results in a large overhead associated with indicating/reserving a large number of REs (e.g., to be used from an even greater number of REs constituting a whole radar resource pool).

Aspects of the present disclosure provide apparatuses, methods, processing systems, and computer-readable mediums for partitioning a radar band (e.g., indicated by a radar resource pool configuration) into multiple non-overlapping subbands where each subband uses a different RE shape (e.g., a frequency size and a time duration) that is matched to a different radar device waveform. In some cases, REs associated with a same subband may have a same shape, and the REs associated with different subbands may have different shapes. In one example, a first subband may be defined for a long-range radar device (e.g., a small bandwidth) and a second subband may be defined for a short-range radar device (e.g., a large bandwidth). Techniques described herein may improve resource utilization efficiency while the resource reservation overhead remains reasonable.

FIG. 8 illustrates example operations 800 for wireless communication. The operations 800 may be performed, for example, by a radar device (e.g., such as UE 104 comprising a radar device in wireless communication network 100 of FIG. 1). The operations 800 may be implemented as software components that are executed and run on one or more processors (e.g., controller/processor 280 of FIG. 2). Further, transmission and reception of signals by the UE in the operations 800 may be enabled, for example, by one or more antennas (e.g., antennas 252 of FIG. 2). In certain aspects, the transmission and/or reception of signals by the UE may be implemented via a bus interface of one or more processors (e.g., the controller/processor 280) obtaining and/or outputting signals.

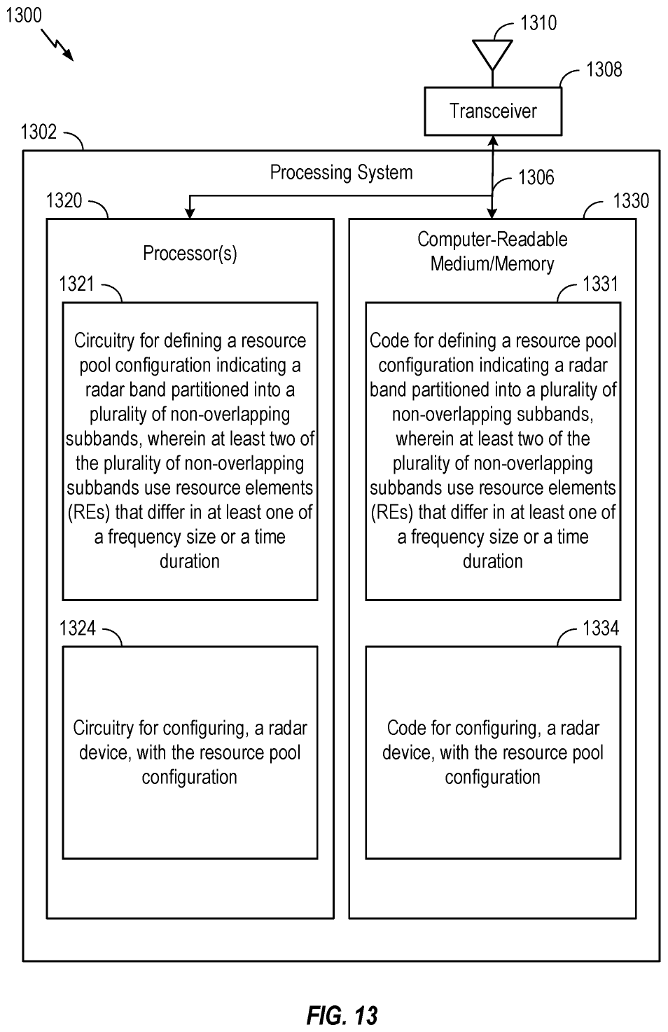

The operations 800 begin, at 810, by determining a resource pool configuration indicating a radar band partitioned into a plurality of non-overlapping subbands. At least two of the plurality of non-overlapping subbands use resource elements (REs) that differ in at least one of a frequency size or a time duration. For example, the radar device may determine the resource pool configuration using a processor of UE 104 shown in FIG. 1 or FIG. 2 and/or of the apparatus shown in FIG. 13.

At 820, the radar device transmits a radar waveform using at least one RE within a subband of the plurality of non-overlapping subbands. For example, the radar device may transmit the radar waveform using antenna(s) and/or transmitter/transceiver components of UE 104 shown in FIG. 1 or FIG. 2 and/or of the apparatus shown in FIG. 13.

FIG. 9 illustrates example operations 900 for wireless communication. The operations 900 may be performed, for example, by a network entity (e.g., such as BS 102 in wireless communication network 100 of FIG. 1). The operations 900 may be implemented as software components that are executed and run on one or more processors (e.g., controller/processor 240 of FIG. 2). Further, transmission and reception of signals by the network entity in the operations 900 may be enabled, for example, by one or more antennas (e.g., antennas 234 of FIG. 2). In certain aspects, the transmission and/or reception of signals by the network entity may be implemented via a bus interface of one or more processors (e.g., the controller/processor 240) obtaining and/or outputting signals.

The operations 900 begin, at 910, by defining a resource pool configuration indicating a radar band partitioned into a plurality of non-overlapping subbands. At least two of the plurality of non-overlapping subbands use REs that differ in at least one of a frequency size or a time duration. For example, the network entity may define the resource pool configuration using a processor of BS 102 shown in FIG. 1 or FIG. 2 and/or of the apparatus shown in FIG. 14.

At 920, the network entity configures, a radar device, with the resource pool configuration. For example, the network entity may configure the radar device with the resource pool configuration using a processor, antenna(s) and/or transmitter/transceiver components of BS 102 shown in FIG. 1 or FIG. 2 and/or of the apparatus shown in FIG. 14.

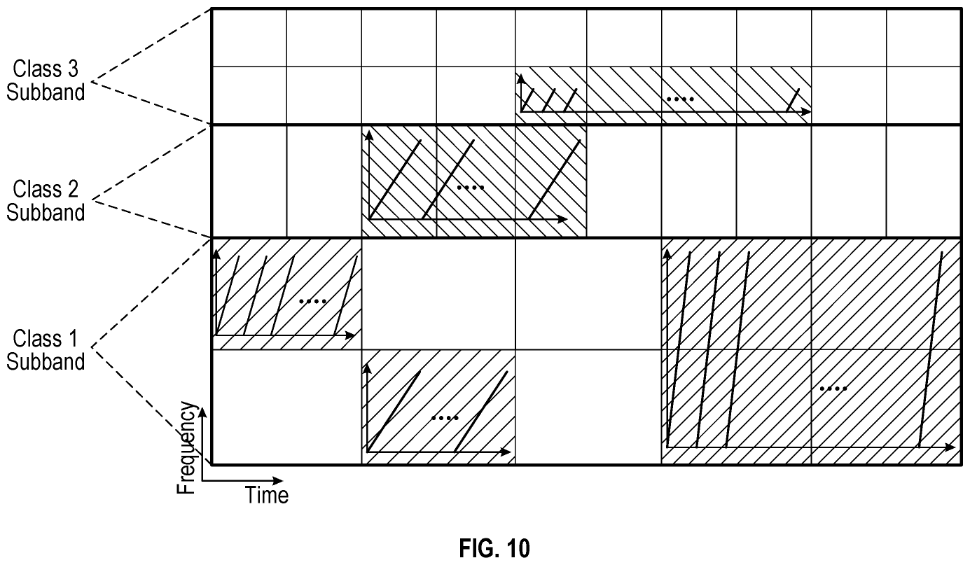

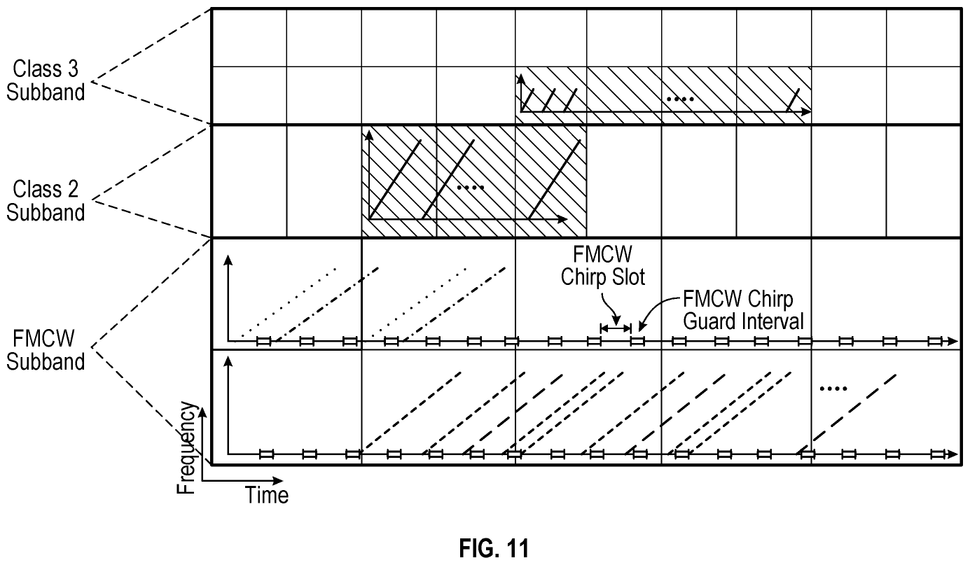

The operations shown in FIGS. 8 and 9 may be understood with reference to the FIGS. 10-11.

As illustrated in FIG. 10, 3 subbands (e.g., indicated by a resource pool configuration) include a class 1 subband, a class 2 subband, and a class 3 subband. Each subband includes multiple REs. In certain aspects, different shapes of the REs of the subbands match with at least a frequency size and a time duration of different radar waveforms of different radar devices. In some cases, all the radar devices may follow a same time reference (e.g., global positioning system (GPS)), and slot timings are with respect to the time reference.

In certain aspects, the radar device selects a subband of the plurality of non-overlapping subbands for transmitting the radar waveform based on a first predetermined criterion. The first predetermined criterion may be satisfied when a smallest number of REs per radar waveform are used based on the selected subband. For instance, the radar device may select the subband that results in a fewest number of REs used per transmission burst (e.g., the class 2 subband of FIG. 10). For example, if a certain radar device transmission requires 10 REs of a first subchannel (if transmitted on the first subchannel), and 14 REs of a second subchannel (if transmitted on the second subchannel), the transmission is then performed on the first subchannel (e.g., based on the first predetermined criterion).

In certain aspects, the radar device selects the subband of the plurality of non-overlapping subbands for transmitting the radar waveform based on a second predetermined criterion. The second predetermined criterion may be satisfied when a value (e.g., based on a number of the REs used per radar waveform and time-frequency resources of each RE) is as small as possible (e.g., the value may be less than or more than a certain threshold). For example, the radar device may select the subband that results in a value ((a number of REs per transmission burst)×(a time-frequency product of each RE)) to be as small as possible.

In certain aspects, the radar device receives from a wireless node a message indicating the subband of the plurality of non-overlapping subbands for transmitting the radar waveform. In some cases, the wireless node is a network entity, and the message is received via a downlink control information (DCI). In some cases, the wireless node is another radar device, and the message is received via a sidelink control information (SCI).

In one example, the message may be a downlink message received via Uu (e.g., as part of a radio resource control (RRC) configuration). In another example, the message may be a sidelink message received via PC5. In another example, the message may be a portion of a data payload, which is indicated in a medium access control (MAC) control element (CE) or in DCI/SCI. In another example, the message be a unicast message. In another example, the message be a groupcast message (e.g., a group of radar devices/UEs assigned to a same band with a single message)

In certain aspects, the radar device selects a resource within the subband. For example, the radar device selects at least one RE within the subband for transmitting the radar waveform. In certain aspects, the wireless node selects and indicates the resource within the subband. For example, the message by the wireless node may also indicate the at least one RE within the subband to use for transmitting the radar waveform.

In certain aspects, the resource pool configuration of the radar band is preconfigured in the radar device (e.g., as a default configuration). In one example, the resource pool configuration may depend on a location of the radar device. In another example, the resource pool configuration may depend on a time of operation. In some cases, the default configuration may also indicate that no resource pool is defined (i.e., there is no scheduled channel access support).

In certain aspects, the network entity transmits an indication indicating an index of a table of a plurality of resource pool configurations (e.g., preconfigured or known resource pool configurations) to the radar device. The radar device then determines the resource pool configuration of the radar band based on the index. In certain aspects, the network entity explicitly indicates the resource pool configuration to the radar device. In one example, the indication is received from the network entity periodically. In another example, the indication is received from the network entity based on a request from the radar device. In one example, the indication may be a portion of a data payload, which is indicated in a MAC-CE or in DCI. In another example, the indication be a unicast message. In another example, the indication be a groupcast message. In another example, the indication be a broadcast message.

In certain aspects, the resource pool configuration indicates (e.g., for each of the plurality of non-overlapping subbands of the radar band) a starting frequency (e.g., a lowest frequency). In one example, the resource pool configuration may indicate a size of each subchannel. A first subchannel may start at a lowest subband frequency. In some cases, all subchannels may have a same size (e.g., in frequency). In another example, the resource pool configuration may indicate a number of subchannels within a subband.

In certain aspects, the resource pool configuration indicates (e.g., for each of the plurality of non-overlapping subbands of the radar band) a guard band size. For example, subchannels may be consecutive in frequency and separated by an indicated guard band (e.g., same for all pairs of subchannels). In some cases, the guard band size may be zero (e.g., no guard band). In some cases, the resource pool configuration may also indicate a size (e.g., duration) of each slot.

In certain aspects, the resource pool configuration indicates (e.g., for each of the plurality of non-overlapping subbands of the radar band) a guard interval duration. For example, slots may be consecutive in time and separated by the indicated guard interval. In some cases, the guard interval duration may be zero (e.g., no guard interval).

In certain aspects, the resource pool configuration indicates (e.g., for FMCW subbands) a chirp slot duration. In some cases, the resource pool configuration may also indicate a set of FMCW parameters. The set of FMCW parameters may include a bandwidth, a carrier frequency, a chirp transmission duration, upchirp intervals, downchirp intervals, a number of chirp transmissions per frame, a chirp transmission period within a frame, a frame period, and/or a sampling frequency.

In certain aspects (e.g., for scenarios when there is less congestion of radar devices), the radar device may receive signaling from the network entity indicating that no resource pool is configured. This is because there may be no need for scheduling the radar device. In such cases, the network entity may indicate to all radar devices that the radar devices may transmit radar waveforms without any restriction or may use a contention-based (e.g., listen before talk (LBT) based) channel access (according to a pre-configured procedure).

In certain aspects, to achieve efficient resource utilization, the resource pool configuration is dynamically adapted to a current operational condition. The current operation condition indicates resource requirements of different radar devices in operation. For example, the radar band that is partitioned to support two radar classes can adapt bandwidth allocation for two radar subbands, based on resource demands of the radar devices currently in a field. For example, more bandwidth may be allocated to a radar subband corresponding to a class that most radar devices in the field belong to.

In certain aspects, when the resource pool configuration only supports a specific (non-changeable) set of classes of the radar devices, a vehicle (e.g., with the radar devices) may indicate a class of its radar devices to the network entity. The vehicle may know all supported classes of the radar devices. The technique described herein reduces an overhead of signaling with a cost of restricting to a fixed number of radar subbands/classes.

In certain aspects, each radar device transmits to the network entity a message indicating the resource requirements of the radar device. The resource requirements may include a radar waveform bandwidth, a duration of the radar waveform, and/or a period or a duty cycle of the radar waveform. In one example, the message is transmitted to the network entity periodically (e.g., using a pre-configured period or a period indicated by the network entity). In another example, the message is transmitted to the network entity based on a request from the network entity. The request may be a broadcast message (e.g., all radar devices in range report), a groupcast message (e.g., a specific group of radar devices report), and/or a unicast message (e.g., a single vehicle/radar device report).

In some cases, conventional approaches aim towards efficiently multiplexing (e.g., packing) arbitrary (e.g., incompatible) radar waveforms (e.g., of FMCW and pulse-modulated continuous wave (PMCW) radar devices). However, if the radar waveforms to be multiplexed are of a same type, higher efficiency may be achievable.

For example, the FMCW radar devices transmitting an exact same waveform (not necessarily at an exact same time) can be more efficiently multiplexed (in time) using, so called, chirp slots. For example, time is partitioned into the chirp slots with guard intervals between them. As long as any two radar devices start their chirp transmissions on different chirp slots (and it does not matter where within the chirp slots), the chirp transmissions will not interfere with each other (even if the chirp transmissions are partially overlapping).

Techniques described herein achieve a tight packing of the FMCW radar devices when the FMCW radar devices follow an exact same configuration. For example, all long-range FMCW radar devices may follow a same first configuration as defined by a network entity. In another example, all short-range FMCW radar devices may follow a same second configuration as defined by the network entity. In some cases, deviations from a common configuration may be allowable when the chirp slots are designed appropriately.

In certain aspects, at least one of the plurality of non-overlapping subbands accommodates FMCW-specific multiplexing. For instance, a subband is dedicated only to the FMCW radar devices (e.g., assuming all the FMCW radar devices follow the same configuration). In one example, a first subband of the plurality of non-overlapping subbands may support the FMCW radar devices with a first common configuration for long-range radar applications. In another example, a second subband of the plurality of non-overlapping subbands may support the FMCW radar devices with a second common configuration for short-range radar applications.

For example, as illustrated in FIG. 11, a plurality of non-overlapping subbands include a FMCW subband (e.g., dedicated to FMCW signals from the FMCW radar devices with same parameters/configuration), a class 2 subband, and a class 3 subband. The FMCW subband is partitioned into one or more subchannels. A subchannel is partitioned into one or more chirps slots and one or more guard intervals. The FMCW radar device may transmit its chirp anytime within a chirp slot.

### Example Wireless Communication Devices

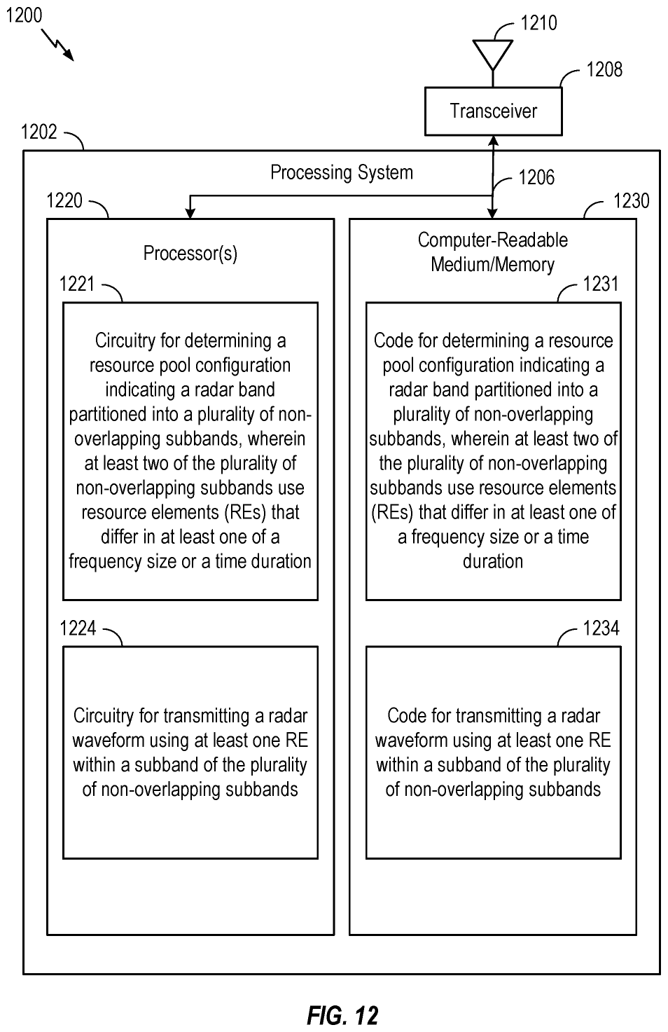

FIG. 12 depicts an example communications device 1200 that includes various components operable, configured, or adapted to perform operations for the techniques disclosed herein, such as the operations depicted and described with respect to FIG. 8. In some examples, communication device 1200 may be a UE 104 (comprising a radar device) as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIG. 8, or other operations for performing the various techniques discussed herein.

In the depicted example, computer-readable medium/memory 1230 stores code 1231 for determining a resource pool configuration indicating a radar band partitioned into a plurality of non-overlapping subbands where at least two of the plurality of non-overlapping subbands use resource elements (REs) that differ in at least one of a frequency size or a time duration, and code 1234 for transmitting a radar waveform using at least one RE within a subband of the plurality of non-overlapping subbands.

In the depicted example, the one or more processors 1220 include circuitry configured to implement the code stored in the computer-readable medium/memory 1230, including circuitry 1221 for determining a resource pool configuration indicating a radar band partitioned into a plurality of non-overlapping subbands where at least two of the plurality of non-overlapping subbands use REs that differ in at least one of a frequency size or a time duration, and circuitry 1224 for transmitting a radar waveform using at least one RE within a subband of the plurality of non-overlapping subbands.

Various components of communications device 1200 may provide means for performing the methods described herein, including with respect to FIG. 8.

In some examples, means for transmitting or sending (or means for outputting for transmission) may include the transceivers 254 and/or antenna(s) 252 of the UE 104 illustrated in FIG. 2 and/or transceiver 1208 and antenna 1210 of the communication device 1200 in FIG. 12.

In some examples, means for receiving (or means for obtaining) may include the transceivers 254 and/or antenna(s) 252 of the UE 104 illustrated in FIG. 2 and/or transceiver 1208 and antenna 1210 of the communication device 1200 in FIG. 12.

In some examples, means for determining a resource pool configuration indicating a radar band partitioned into a plurality of non-overlapping subbands where at least two of the plurality of non-overlapping subbands use REs that differ in at least one of a frequency size or a time duration, and means for transmitting a radar waveform using at least one RE within a subband of the plurality of non-overlapping subbands, may include various processing system components, such as: the one or more processors 1320 in FIG. 13, or aspects of the UE 104 depicted in FIG. 2, including receive processor 258, transmit processor 264, TX MIMO processor 266, and/or controller/processor 280 (including radar component 281).

Notably, FIG. 12 is an example, and many other examples and configurations of communication device 1200 are possible.

FIG. 13 depicts an example communications device 1300 that includes various components operable, configured, or adapted to perform operations for the techniques disclosed herein, such as the operations depicted and described with respect to FIG. 9. In some examples, communication device 1300 may be a BS 102 as described, for example with respect to FIGS. 1 and 2.

Communications device 1300 includes a processing system 1302 coupled to a transceiver 1308 (e.g., a transmitter and/or a receiver). Transceiver 1308 is configured to transmit (or send) and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes one or more processors 1320 coupled to a computer-readable medium/memory 1330 via a bus 1306. In certain aspects, computer-readable medium/memory 1330 is configured to store instructions (e.g., computer-executable code) that when executed by the one or more processors 1320, cause the one or more processors 1320 to perform the operations illustrated in FIG. 9, or other operations for performing the various techniques discussed herein.

In the depicted example, computer-readable medium/memory 1330 stores code 1331 for defining a resource pool configuration indicating a radar band partitioned into a plurality of non-overlapping subbands where at least two of the plurality of non-overlapping subbands use REs that differ in at least one of a frequency size or a time duration, and code 1334 for configuring a radar device with the resource pool configuration.

In the depicted example, the one or more processors 1320 include circuitry configured to implement the code stored in the computer-readable medium/memory 1330, including circuitry 1321 for defining a resource pool configuration indicating a radar band partitioned into a plurality of non-overlapping subbands where at least two of the plurality of non-overlapping subbands use REs that differ in at least one of a frequency size or a time duration, and circuitry 1324 for configuring a radar device with the resource pool configuration.

Various components of communications device 1300 may provide means for performing the methods described herein, including with respect to FIG. 9.

In some examples, means for transmitting or sending (or means for outputting for transmission) may include the transceivers 232 and/or antenna(s) 234 of the BS 102 illustrated in FIG. 2 and/or transceiver 1308 and antenna 1310 of the communication device 1300 in FIG. 13.

In some examples, means for receiving (or means for obtaining) may include the transceivers 232 and/or antenna(s) 234 of the BS illustrated in FIG. 2 and/or transceiver 1308 and antenna 1310 of the communication device 1300 in FIG. 13.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for defining a resource pool configuration indicating a radar band partitioned into a plurality of non-overlapping subbands where at least two of the plurality of non-overlapping subbands use REs that differ in at least one of a frequency size or a time duration, and means for configuring a radar device with the resource pool configuration, may include various processing system components, such as: the one or more processors 1320 in FIG. 14, or aspects of the BS 102 depicted in FIG. 2, including receive processor 238, transmit processor 220, TX MIMO processor 230, and/or controller/processor 240 (including resource pool component 241).

Notably, FIG. 13 is an example, and many other examples and configurations of communication device 1300 are possible.

### Example Clauses

Implementation examples are described in the following numbered clauses:

Clause 1: A method for wireless communication by a radar device, comprising: determining a resource pool configuration indicating a radar band partitioned into a plurality of non-overlapping subbands, wherein at least two of the plurality of non-overlapping subbands use resource elements (REs) that differ in at least one of a frequency size or a time duration; and transmitting a radar waveform using at least one RE within a subband of the plurality of non-overlapping subbands.

Clause 2: The method alone or in combination with the first clause, wherein different shapes of the REs of the plurality of non-overlapping subbands match with at least a frequency size and a time duration of different radar waveforms of different radar devices.

Clause 3: The method alone or in combination with one or more of the first and second clauses, further comprising selecting the subband of the plurality of non-overlapping subbands for transmitting the radar waveform based on a first predetermined criteria, the first predetermined criteria is satisfied when a smallest number of the REs per radar waveform are used based on the selected subband.

Clause 4: The method alone or in combination with one or more of the first through third clauses, further comprising selecting the subband of the plurality of non-overlapping subbands for transmitting the radar waveform based on a second predetermined criteria, the second predetermined criteria is satisfied when a value based on a number of the REs used per radar waveform and time-frequency resources of each RE is less than a threshold.

Clause 5: The method alone or in combination with one or more of the first through fourth clauses, further comprising receiving, from a wireless node, a message indicating the subband of the plurality of non-overlapping subbands for transmitting the radar waveform.

Clause 6: The method alone or in combination with one or more of the first through fifth clauses, further comprising selecting the at least one RE within the subband of the plurality of non-overlapping subbands indicated within the message for transmitting the radar waveform.

Clause 7: The method alone or in combination with one or more of the first through sixth clauses, wherein the message further indicates the at least one RE within the subband of the plurality of non-overlapping subbands to use for transmitting the radar waveform.

Clause 8: The method alone or in combination with one or more of the first through seventh clauses, wherein the wireless node comprises a network entity, and wherein the message is received via a downlink control information (DCI).

Clause 9: The method alone or in combination with one or more of the first through eighth clauses, wherein the wireless node comprises another radar device, and wherein the message is received via a sidelink control information (SCI).

Clause 10: The method alone or in combination with one or more of the first through ninth clauses, wherein the message is a unicast message or a groupcast message.

Clause 11: The method alone or in combination with one or more of the first through tenth clauses, wherein at least one of the plurality of non-overlapping subbands is for a frequency-modulated continuous wave (FMCW) radar device.

Clause 12: The method alone or in combination with one or more of the first through eleventh clauses, wherein the at least one of the plurality of non-overlapping subbands comprises one or more subchannels, each subchannel is partitioned into one or more chirps slots and one or more guard intervals.

Clause 13: The method alone or in combination with one or more of the first through twelfth clauses, wherein the resource pool configuration of the radar band is preconfigured in the radar device.

Clause 14: The method alone or in combination with one or more of the first through thirteenth clauses, wherein the resource pool configuration of the radar band depends on one or more of: a location of the radar device and a time.

Clause 15: The method alone or in combination with one or more of the first through fourteenth clauses, wherein the determining comprising: receiving, from a network entity, signaling indicating an index of a table of a plurality of resource pool configurations; and determining the resource pool configuration of the radar band based on the index.

Clause 16: The method alone or in combination with one or more of the first through fifteenth clauses, wherein the signaling is received from the network entity either periodically or based on a request from the radar device.

Clause 17: The method alone or in combination with one or more of the first through sixteenth clauses, wherein the determining comprising: receiving, from a network entity, signaling indicating the resource pool configuration of the radar band; and using the resource pool configuration of the radar band.

Clause 18: The method alone or in combination with one or more of the first through seventeenth clauses, wherein the signaling is received from the network entity either periodically or based on a request from the radar device.

Clause 19: The method alone or in combination with one or more of the first through eighteenth clauses, wherein the resource pool configuration indicates for each of the plurality of non-overlapping subbands of the radar band one or more of: a starting frequency; a size of each subchannel; a number of subchannels; a guard band size; a size of each slot; a guard interval duration; a chirp slot duration; and a set of frequency-modulated continuous wave (FMCW) parameters, the set of FMCW parameters comprises one or more of: a bandwidth, a carrier frequency, a chirp transmission duration; upchirp intervals; downchirp intervals; a number of chirp transmissions per frame; a chirp transmission period within a frame; a frame period; and a sampling frequency.

Clause 20: The method alone or in combination with one or more of the first through nineteenth clauses, further comprising receiving, from a network entity, signaling indicating no resource pool is configured.

Clause 21: The method alone or in combination with one or more of the first through twentieth clauses, wherein the resource pool configuration is dynamically adapted to allocate bandwidth in each of the plurality of non-overlapping subbands based on a current operation condition, the current operation condition indicates resource requirements of different radar devices in operation.

Clause 22: The method alone or in combination with one or more of the first through twenty-first clauses, further comprising transmitting, to a network entity, a message indicating resource requirements of the radar device, the resource requirements comprises one or more of: a radar waveform bandwidth, a duration of the radar waveform, and a period or a duty cycle of the radar waveform.

Clause 23: The method alone or in combination with one or more of the first through twenty-second clauses, wherein the message is transmitted to the network entity either periodically or based on a request from the network entity.

Clause 24: A method for wireless communication by a network entity, comprising: defining a resource pool configuration indicating a radar band partitioned into a plurality of non-overlapping subbands, wherein at least two of the plurality of non-overlapping subbands use resource elements (REs) that differ in at least one of a frequency size or a time duration; and configuring, a radar device, with the resource pool configuration.

Clause 25: The method alone or in combination with the twenty-fourth clause, wherein different shapes of the REs of the plurality of non-overlapping subbands match with at least a frequency size and a time duration of different radar waveforms of different radar devices.

Clause 26: The method alone or in combination with one or more of the twenty-fourth and twenty-fifth clauses, wherein the at least one processor is further configured to: transmit, to the radar device, a message indicating a subband of the plurality of non-overlapping subbands for transmitting a radar waveform.

Clause 27: An apparatus, comprising: a memory comprising executable instructions; and one or more processors configured to execute the executable instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by one or more processors of an apparatus, cause the apparatus to perform a method in accordance with any one of Clauses 1-26.

Clause 30: A computer program product embodied on a computer-readable storage medium comprising code for performing a method in accordance with any one of Clauses 1-26.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mm Wave frequencies, the BS 180 may be referred to as an mmWave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of defining a radar resource pool for interference-free multi-radar co-existence in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication by a radar device, comprising: at least one processor and a memory configured to:
determine a resource pool configuration indicating a radar band partitioned into a plurality of non-overlapping subbands, wherein at least two of the plurality of non-overlapping subbands use resource elements (REs) that differ in at least one of a frequency size or a time duration; and
transmit a radar waveform using at least one RE within a subband of the plurality of non-overlapping subbands.

2. The apparatus of claim 1, wherein different shapes of the REs of the plurality of non-overlapping subbands match with at least a frequency size and a time duration of different radar waveforms of different radar devices.

3. The apparatus of claim 1, wherein the at least one processor is further configured to select the subband of the plurality of non-overlapping subbands for transmitting the radar waveform based on a first predetermined criteria, the first predetermined criteria is satisfied when a smallest number of the REs per radar waveform are used based on the selected subband.

4. The apparatus of claim 1, wherein the at least one processor is further configured to select the subband of the plurality of non-overlapping subbands for transmitting the radar waveform based on a second predetermined criteria, the second predetermined criteria is satisfied when a value based on a number of the REs used per radar waveform and time-frequency resources of each RE is less than a threshold.

5. The apparatus of claim 1, wherein the at least one processor is further configured to receive, from a wireless node, a message indicating the subband of the plurality of non-overlapping subbands for transmitting the radar waveform.

6. The apparatus of claim 5, wherein the at least one processor is further configured to select the at least one RE within the subband of the plurality of non-overlapping subbands indicated within the message for transmitting the radar waveform.

7. The apparatus of claim 5, wherein the message further indicates the at least one RE within the subband of the plurality of non-overlapping subbands to use for transmitting the radar waveform.

8. The apparatus of claim 5, wherein the wireless node comprises a network entity, and wherein the message is received via a downlink control information (DCI).

9. The apparatus of claim 5, wherein the wireless node comprises another radar device, and wherein the message is received via a sidelink control information (SCI).

10. The apparatus of claim 5, wherein the message is a unicast message or a groupcast message.

11. The apparatus of claim 1, wherein at least one of the plurality of non-overlapping subbands is for a frequency-modulated continuous wave (FMCW) radar device.

12. The apparatus of claim 11, wherein the at least one of the plurality of non-overlapping subbands comprises one or more subchannels, each subchannel is partitioned into one or more chirps slots and one or more guard intervals.

13. The apparatus of claim 1, wherein the resource pool configuration of the radar band is preconfigured in the radar device.

14. The apparatus of claim 13, wherein the resource pool configuration of the radar band depends on one or more of: a location of the radar device and a time.

15. The apparatus of claim 1, wherein the at least one processor is configured to determine by:
receiving, from a network entity, signaling indicating an index of a table of a plurality of resource pool configurations; and
determining the resource pool configuration of the radar band based on the index.

16. The apparatus of claim 15, wherein the signaling is received from the network entity either periodically or based on a request from the radar device.

17. The apparatus of claim 1, wherein the at least one processor is configured to determine by:
receiving, from a network entity, signaling indicating the resource pool configuration of the radar band; and
using the resource pool configuration of the radar band.

18. The apparatus of claim 17, wherein the signaling is received from the network entity either periodically or based on a request from the radar device.

19. The apparatus of claim 1, wherein the resource pool configuration indicates for each of the plurality of non-overlapping subbands of the radar band one or more of:
a starting frequency,
a size of each subchannel,
a number of subchannels,
a guard band size,
a size of each slot,
a guard interval duration,
a chirp slot duration, and
a set of frequency-modulated continuous wave (FMCW) parameters, the set of FMCW parameters comprises one or more of:
a bandwidth,
a carrier frequency,
a chirp transmission duration,
upchirp intervals,
downchirp intervals,
a number of chirp transmissions per frame,
a chirp transmission period within a frame,
a frame period, and
a sampling frequency.

20. The apparatus of claim 1, wherein the at least one processor is further configured to receive, from a network entity, signaling indicating no resource pool is configured.

21. The apparatus of claim 1, wherein the resource pool configuration is dynamically adapted to allocate bandwidth in each of the plurality of non-overlapping subbands based on a current operation condition, the current operation condition indicates resource requirements of different radar devices in operation.

22. The apparatus of claim 1, wherein the at least one processor is further configured to transmit, to a network entity, a message indicating resource requirements of the radar device, the resource requirements comprises one or more of:
a radar waveform bandwidth,
a duration of the radar waveform, and
a period or a duty cycle of the radar waveform.

23. The apparatus of claim 22, wherein the message is transmitted to the network entity either periodically or based on a request from the network entity.

24. An apparatus for wireless communication by a network entity, comprising: at least one processor and a memory configured to:
define a resource pool configuration indicating a radar band partitioned into a plurality of non-overlapping subbands, wherein at least two of the plurality of non-overlapping subbands use resource elements (REs) that differ in at least one of a frequency size or a time duration; and
configure, a radar device, with the resource pool configuration.

25. The apparatus of claim 24, wherein different shapes of the REs of the plurality of non-overlapping subbands match with at least a frequency size and a time duration of different radar waveforms of different radar devices.

26. The apparatus of claim 24, wherein the at least one processor is further configured to: transmit, to the radar device, a message indicating a subband of the plurality of non-overlapping subbands for transmitting a radar waveform.

27. A method for wireless communication by a radar device, comprising:
determining a resource pool configuration indicating a radar band partitioned into a plurality of non-overlapping subbands, wherein at least two of the plurality of non-overlapping subbands use resource elements (REs) that differ in at least one of a frequency size or a time duration; and
transmitting a radar waveform using at least one RE within a subband of the plurality of non-overlapping subbands.

28. The method of claim 27, wherein different shapes of the REs of the plurality of non-overlapping subbands match with at least a frequency size and a time duration of different radar waveforms of different radar devices.

29. A method for wireless communication by a network entity, comprising:
defining a resource pool configuration indicating a radar band partitioned into a plurality of non-overlapping subbands, wherein at least two of the plurality of non-overlapping subbands use resource elements (REs) that differ in at least one of a frequency size or a time duration; and
configuring, a radar device, with the resource pool configuration.

30. The method of claim 29, wherein different shapes of the REs of the plurality of non-overlapping subbands match with at least a frequency size and a time duration of different radar waveforms of different radar devices.
